(19) United States
(12) Patent Application Publication
(10) Pub. No.: US 2024/0147911 A1
(43) Pub. Date: May 9, 2024

(54) WINDROWER

(71) Applicant: Maschinenfabrik Bernard Krone GmbH & Co. KG, Spelle (DE)

(72) Inventors: Andreas AFTING, Emsbüren (DE); Christian OSTHUES, Horstel (DE); Sebastian HASSIG, Voltlage (DE); Jan HORSTMANN, Rheine (DE); Josef HORSTMANN, Ibbenbüren (DE)

(21) Appl. No.: 18/502,689

(22) Filed: Nov. 6, 2023

(30) Foreign Application Priority Data
Nov. 9, 2022 (DE) DE102022129617.2

(51) Int. Cl. A01D 89/00; A01D 78/04

(52) U.S. Cl. CPC A01D 89/008; A01D 89/002; A01D 78/04

(57) ABSTRACT

The invention relates to a windrower (1) having at least one pickup device (10), which has a pickup rotor (11) and a transfer rotor (14), which can be driven in the same direction about axes of rotation (A, B) which extend at least predominantly along a transverse axis (Y), wherein the pickup rotor (11) is configured to pick up agricultural crop material from the ground (70) by means of pickup prongs (12), to lift it in relation to a vertical axis (Z) and to transfer it to the transfer rotor (14), which is arranged at least in part higher than the pickup rotor (11) and is configured to take over the crop material by means of transfer prongs (15), to lift it at least initially in relation to the vertical axis (Z) and to transfer it to a downstream transverse conveyor (30), which is arranged at least in part behind the pickup device (10) in relation to a longitudinal axis (X) and is configured to receive the crop material transferred by the transfer rotor (14) on a conveying surface (36), to convey it along the transverse axis (Y) by means of a conveying element (32) and to deposit it in windrows on the ground (70), wherein the transfer rotor (14) is configured to discharge at least some of the crop material above the conveying surface (36) in relation to the vertical axis (Z) and to throw it onto the said surface. In order, in the case of a windrower, to enable crop material to be efficiently picked up and transferred to a transverse conveyor, it is envisaged according to the invention that, in at least one working position of the windrower (1), a normal straight line (N), which runs perpendicular to a region (37) of the conveying surface that is central in relation to the longitudinal axis (X) and which runs through a point (38) on the conveying element (32) that is furthest forward in relation to the longitudinal axis (X), at least touches a range of movement (D) of the transfer prongs (15).

### CROSS REFERENCE TO RELATED APPLICATIONS

This application claims priority under 35 U.S.C. § 119 to German Patent Application DE 10 2022 129617.2, filed Nov. 9, 2022, which is herein incorporated by reference in its entirety, including without limitation, the specification, claims, and abstract, as well as any figures, tables, appendices, or drawings thereof.

### FIELD OF THE INVENTION

The present invention relates to a windrower.

### BACKGROUND OF THE INVENTION

The background description provided herein gives context for the present disclosure. Work of the presently named inventors and aspects of the description that may not otherwise qualify as prior art at the time of filing are neither expressly nor impliedly admitted as prior art.

Various agricultural machines, such as windrowers, balers, or self-loading forage boxes, pick up crop material, e.g., grass or hay, lying on the ground during cultivation in order, for example, to process it, transport it away or—in the case of a windrower—to move it and deposit it at some other point. To pick up the crop material, a pickup device or pickup can be used, and this is generally arranged at the front of the agricultural machine and is guided over the ground with a small clearance. The crop material is lifted off the ground by means of a pickup rotor, which rotates about an axis extending in the transverse direction. The crop material picked up can be transferred directly to a downstream device. The transfer is assisted in part by a second rotor. In the case of a belt-type windrower, the crop material is transferred to a transverse conveyor, which conveys the crop material by means of a conveyor belt or the like transversely to the direction of travel and deposits it again at the side.

Depending on the quantity and characteristics of the crop material, problems may be encountered in picking up, conveying, and transferring the crop material by means of the pickup device, and these may disrupt the flow of crop material and/or lead to impairment of the quality of the crop material. One problem is that the prongs of the pickup rotor move close to the ground counter to the direction of travel, and only as rotation progresses do they move upwards and then rearwards counter to the direction of travel. The unavoidable movement counter to the direction of travel can lead to the crop material being pushed or flung forward. Moreover, optimum transfer to the transverse conveyor is difficult to achieve. In particular, local accumulation of crop material on the transverse conveyor and missing of the transverse conveyor should be avoided in this context.

Therefore, there is a strong need for a windrower to allow efficient picking up of crop material and transfer thereof to a transverse conveyor.

### SUMMARY OF THE INVENTION

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

An aspect of the invention is a windrower having at least one pickup device, which has a pickup rotor and a transfer rotor, which can be driven in the same direction about axes of rotation which extend at least predominantly along a transverse axis, wherein the pickup rotor is configured to pick up agricultural crop material from the ground by means of pickup prongs, to lift it in relation to a vertical axis and to transfer it to the transfer rotor, which is arranged at least in part higher than the pickup rotor and is configured to take over the crop material by means of transfer prongs, to lift it at least initially in relation to the vertical axis and to transfer it to a downstream transverse conveyor, which is arranged at least in part behind the pickup device in relation to a longitudinal axis and is configured to receive the crop material transferred by the transfer rotor on a conveying surface, to convey it along the transverse axis by means of a conveying element and to deposit it in windrows on the ground, wherein the transfer rotor is configured to discharge at least some of the crop material above the conveying surface in relation to the vertical axis and to throw it onto the said surface, that includes in at least one working position of the windrower, a normal straight line, which runs perpendicular to a region of the conveying surface that is central in relation to the longitudinal axis and which runs through a point on the conveying element that is furthest forward in relation to the longitudinal axis, at least touches a range of movement of the transfer prongs.

Another aspect of the present invention is a method for operating a windrower according to the preceding paragraph above, wherein the windrower has at least one windrower unit, which has the pickup device and the transverse conveyor, characterized in that at least one operating parameter of the windrower unit is adapted to influence distribution of the crop material on the conveying surface.

For this purpose, a windrower is provided which has at least one pickup device, which has a pickup rotor and a transfer rotor, which can be driven in the same direction about axes of rotation which extend at least predominantly along a transverse axis, wherein the pickup rotor is configured to pick up agricultural crop material from the ground by means of pickup prongs, to lift it in relation to a vertical axis and to transfer it to the transfer rotor, which is arranged at least in part higher than the pickup rotor and is configured to take over the crop material by means of transfer prongs, to lift it at least initially in relation to the vertical axis and to transfer it to a downstream transverse conveyor, which is arranged at least in part behind the pickup device in relation to a longitudinal axis and is configured to receive crop material transferred by the transfer rotor on a conveying surface, to convey it along the transverse axis by means of a conveying element and to deposit it in windrows on the ground, wherein the transfer rotor is configured to discharge at least some of the crop material above the conveying surface in relation to the vertical axis and to throw it onto the said surface.

The windrower is used to pick up agricultural crop material, e.g., grass or hay, which is lying on the ground in a flat and/or random way, for example, and to deposit it again in windrows. Machines of this kind are also referred to as mergers or as hay-making machines, and their use is explicitly not restricted to hay. Normally, the windrower does not have its own travel drive and is provided so as to be towed by a tractor or else possibly to be carried as an attachment at the front or rear by an agricultural machine. However, an embodiment with its own travel drive is conceivable.

The windrower can have a main frame, which can be supported by means of an undercarriage in the operating state. The main frame can have the undercarriage, which is thus part of the windrower. If the windrower is designed as an attachment, it is coupled in the operating state to an agricultural machine that has the undercarriage. In either case, at least some of the weight of the windrower can be absorbed and supported on the ground via the main frame and the undercarriage. Moreover, the main frame can be designed for at least an indirect connection to a tractor, and a drawbar used for this purpose can be regarded as part of the main frame. As an alternative, the main frame can have structures for connection to an agricultural machine, which allows use as an attachment.

The pickup device has a pickup rotor and a transfer rotor, which can be driven in the same direction about axes of rotation, which extend at least predominantly along a transverse axis. The transverse axis and the vertical and longitudinal axes mentioned below can be regarded as axes of the pickup device and/or as axes of the windrower. At least in the operating state, the longitudinal axis is normally parallel or anti-parallel to the direction of travel, while the transverse axis is horizontal and perpendicular to the longitudinal axis, and the vertical axis is vertical. In particular, the axes of rotation of the two rotors can be parallel to one another. They extend at least predominantly along the transverse axis, which is to say they are either parallel to the transverse axis or non-parallel to the latter, while the main component of their direction of extent is nevertheless parallel to the transverse axis. In general, the angle between an axis of rotation and the transverse axis is at most 30° or at most 20°. Embodiments in which each rotor is split in two with respect to the transverse axis are conceivable, in which case the rotor halves can be tilted relative to one another. In this case, the alignment of the axis of rotation in the two rotor halves is different but, overall, it is predominantly along the transverse axis. The rotors can be driven in the same direction. It may also be stated that the windrower and/or the pickup device are configured to drive the rotors in the same direction, which is to say, in the same direction of rotation.

The pickup rotor is configured to pick up agricultural crop material from the ground by means of pickup prongs, to lift it in relation to a vertical axis and to transfer it to the transfer rotor. The transfer prongs extend outwards in a radial direction in relation to the axis of rotation of the pickup rotor. They can be arranged on a common rotor core, which is rotatable about the axis of rotation. The pickup prongs are not subject to control, which is to say they are connected—e.g., via the rotor core—in such a way that they cannot rotate relative to one another, but they may be capable of elastic deflection. The pickup prongs can be made of metal but may also be made of other materials, such as plastic or composites. In particular, they can be formed by wire or rods. As an alternative, they could also be formed by sheet metal or comparable sheet-like material. The pickup rotor can be guided along the ground with a small clearance, wherein the pickup prongs pick up the crop material and take it along. In accordance with the rotary motion of the pickup rotor, the crop material is lifted in relation to the vertical axis, although, of course, the movement is not purely vertical; rather, a horizontal motion is superimposed on the lifting movement. Overall, however, the crop material is arranged clearly above the ground when it is transferred to the transfer rotor.

The transfer rotor is arranged at least in part higher than the pickup rotor, which is to say at least part of the transfer rotor is in a position higher than the pickup rotor in relation to the vertical axis. The transfer rotor is configured to take over the crop material by means of transfer prongs, to lift it at least initially in relation to the vertical axis, and to transfer it to a downstream transverse conveyor. The statements made above in relation to the pickup prongs can also be applied to a large extent to the transfer prongs. However, the formation of the transfer prongs from sheet metal or some other sheet-like material is preferred. In a preferred embodiment, the transfer prongs of the transfer rotor are produced from a plastic. Both the pickup prongs and the transfer prongs can be grouped in prong rings which comprise a plurality of prongs, the axial position of which coincides in relation to the axis of rotation. The transfer rotor takes over the crop material and transfers it to the downstream transverse conveyor. Between the point of take-over and that of transfer, the transfer rotor normally conveys the crop material rearwards in relation to the longitudinal axis, i.e., counter to the direction of travel. A vertical movement can be superimposed in turn on this horizontal movement. Overall, the crop material is conveyed upwards and thus lifted not only by the pickup rotor but also by the transfer rotor. In this context, “at least initially” refers to the phase of movement of the crop material, which follows acceptance by the transfer rotor. Of course, the above-explained advantages of splitting the conveying section between two rotors also apply to the upward conveyance of the crop material. While preserving the crop material from damage and maintaining efficiency, it is possible to achieve a conveying height which allows advantageous options with respect to transfer to the downstream transverse conveyor.

The transverse conveyor is arranged at least in part behind the pickup device in relation to a longitudinal axis and is configured to receive the crop material transferred by the transfer rotor on a conveying surface, to convey it along the transverse axis by means of a conveying element and to deposit it in windrows on the ground. The conveying element, which may also be referred to as a conveying member, is drivable and is configured to convey the picked-up crop material on the conveying surface. Here, the conveying surface can be formed completely or partially by the conveying element itself, e.g., if the said element is designed as a conveyor belt or link belt, in which case it is also possible to use the term belt-type windrower. However, it is also conceivable, for example, for the conveying surface to be in part stationary and for the conveying element to move over the conveying surface while, in the process, taking along the crop material, e.g., in the case of a chain conveyor. In the case of a belt-type windrower too, it is possible, for example, for conveyor bars to project laterally beyond a belt element and thus take along the crop material which has missed the actual belt element. In this case, the conveying surface extends beyond the belt element. The conveying surface can be flat overall, and normally at least a region of the conveying surface, which is central in relation to the longitudinal axis is flat. The transverse conveyor normally conveys the crop material parallel to the transverse axis, but it could also convey it at a certain angle to the transverse axis. The transverse conveyor can have a transverse conveyor frame, on which the conveying element is movably mounted. Overall, the transverse conveyor frame imparts mechanical stability to the transverse conveyor and is normally of intrinsically rigid design. The pickup device can be connected to the transverse conveyor. In particular, it can be connected to the main frame via the transverse conveyor frame. The transverse conveyor and/or the pickup device are normally movable relative to the main frame, in particular, are at least vertically movable in relation to the vertical axis. In addition to the vertical mobility, there may also be mobility along the longitudinal axis and/or the transverse axis. Apart from translational movements of the transverse conveyor frame, rotational movement is also conceivable, e.g., transverse oscillation (corresponding to a rotation about the longitudinal axis).

The transfer rotor is configured to discharge at least some of the crop material above the conveying surface in relation to the vertical axis and to throw it onto said surface. This can be achieved in an effective manner since the pickup rotor transfers the crop material to the transfer rotor, which is arranged at a higher level. In all cases, the transfer rotor extends at a higher level than the conveying surface or at least a part thereof. Depending on the embodiment, it may not be possible to determine exactly at what point and thus at what height the crop material is discharged from the transfer rotor. Normally, however, it is possible to identify a typical discharge region. Particularly in the case of a sufficiently high rotational speed, the crop material can be thrown off approximately tangentially from the transfer prongs. It then falls in a normally arc-shaped trajectory onto the conveying surface.

The windrower can have at least one windrower unit, which, for its part, has the pickup device and the transverse conveyor. The windrower unit can be connected at least indirectly to the main frame. Typically, either precisely one windrower unit is provided, or two windrower units are provided. The respective windrower unit can be connected to a side arm which, for its part, is connected to the main frame or forms a part thereof. The windrower unit has those elements of the windrower which, in use as intended, come into direct contact with the crop material and transport the latter.

According to the invention, it is envisaged that, in at least one working position of the windrower, a normal straight line, which runs perpendicular to a region of the conveying surface that is central in relation to the longitudinal axis and which runs through a point on the conveying element that is furthest forward in relation to the longitudinal axis, at least touches a range of movement of the transfer prongs. The working position is a position in which, in use as intended, the windrower is located during cultivation. This can differ from a transport position for road transport, for example. It is possible for the windrower to adopt a plurality of working positions. The arrangement described here applies in at least one working position and, under some circumstances, also in every working position. The normal straight line, which can also be referred to as the “normal”, runs perpendicular to the central region of the conveying surface. In the case of a flat conveying surface, the normal straight line therefore runs perpendicular to the conveying surface. Moreover, it runs through a point on the conveying element, which is furthest forward in relation to the longitudinal axis, and—it may also be stated—through the forwardmost point in the direction of travel. This forwardmost point marks the forward boundary of the region in which crop material can still be engaged directly by the conveying element. The range of movement of a prong is the range through which the prong passes on account of the rotary motion of the rotor. This range of movement is rotationally symmetrical with respect to the axis of rotation of the rotor. When viewed in the direction of the axis of rotation, it is circular or annular. However, the range of movement of the transfer prongs (as a whole) to which reference is made here is cylindrical (and centered around the axis of rotation of the transfer rotor). The normal straight line at least touches the range of movement. It preferably intersects the range of movement. That is to say, it does not bypass the range of movement at the rear in relation to the longitudinal axis. On the one hand, this arrangement of the range of movement and of the normal straight line can be based on the fact that the transfer rotor is at only a short distance from the conveying element or indeed overlaps with it in relation to the longitudinal axis. On the other hand, it can be based on the conveying surface being tilted forwards towards the transfer device. As will be explained below, it is possible, in particular, for there to be a combination of these features. In all cases, it is almost impossible in this arrangement for crop material which falls off or is flung off the transfer rotor to miss the conveying surface or to land in a region which is not covered by the conveying element. This, in turn, is advantageous for transfer as envisaged according to the invention, in which the crop material is not pushed onto the conveying surface but is thrown onto it. Whereas the first of these could be conducive to damaging the crop material, the latter may be regarded as particularly gentle on the crop material.

The transfer prongs preferably engage between the pickup prongs in such a way that the ranges of movement of the transfer prongs and the pickup prongs overlap when viewed along the transverse axis. As already explained above, the range of movement of the transfer prongs is cylindrical overall. The same applies to the range of movement of the pickup prongs. When viewed in the direction of the axis of rotation, the respective ranges of movement are circular or annular. When viewed along the transverse axis, the ranges of movement of the transfer prongs and the pickup prongs overlap in this embodiment. As explained above, the alignment of the transverse axis differs only slightly, or not at all, from that of the axes of rotation. Based on the cylindrical shape of the ranges of movement overall, it is also possible to refer to the ranges of movement as intersecting or interpenetrating, rather than overlapping. It is also possible to state that the sum of the radii of the ranges of movement of a pickup prong and of a transfer prong is greater than the distance between the axes of rotation of the two rotors. Thus, the transfer prongs engage in gaps which are formed between the pickup prongs along the transverse axis. In corresponding fashion, the pickup prongs engage in gaps which are formed between the transfer prongs along the transverse axis. The engagement in the gaps significantly improves the transfer of the crop material. The transfer prongs are capable of directly taking up crop material, which is still between the pickup prongs.

It is advantageous if the pickup device has a stripping device with pickup-prong stripper sections and pickup-prong gaps, which are formed therebetween in relation to the transverse axis and through which the pickup prongs at least partially project, and transfer-prong stripper sections and transfer-prong gaps formed therebetween, through which the transfer prongs at least partially project, wherein the transfer-prong stripper sections are designed in such a way that, as the transfer rotor rotates, the transfer prongs enter between them. The pickup-prong stripper sections can be formed by individual elements, or they can be subsections of a single component. In general, they are manufactured from steel and can be of strip-shaped design, for example. Their function is to at least partially strip crop material from the pickup prongs when the latter moves along the pickup-prong stripper sections in the course of the rotary motion. During this process, the pickup prongs move through pickup-prong gaps, which are formed between the pickup-prong stripper sections. They project, at least in part, through the said gaps. Normally, it is envisaged that they enter or dip down fully between, i.e., are retracted between, the pickup-prong stripper sections in a certain region on their path of movement. They move away from an outer side of the stripping device, on which the crop material can be retained, to an inner side. Under certain circumstances, it would also be possible to conceive of embodiments in which the pickup prongs do not fully retract. In this case, crop material remaining in the region of the tips of the pickup prongs could be taken off by the transfer prongs. The function of the transfer-prong stripper sections in relation to the transfer prongs corresponds to that of the pickup-prong stripper sections in relation to the pickup prongs, which is to say they strip the crop material from the transfer prongs when the latter moves along them. In particular, the transfer prongs are retracted fully between the transfer-prong strippers, which is to say they fully enter the transfer-prong gaps. This allows or imposes complete stripping of the crop material. Even though a distinction is drawn between pickup-prong stripper sections and transfer-prong stripper sections, a pickup-prong stripper section can immediately adjoin a transfer-prong stripper section or even be formed integrally therewith. The transfer-prong gaps are arranged offset from the pickup-prong gaps in relation to the transverse axis. This corresponds to the mutually offset arrangement of the pickup prongs and transfer prongs.

Embodiments in which the pickup-prong gaps and the transfer-prong gaps are separated from one another are conceivable. However, it is preferred that at least one pickup-prong gap merges into a transfer-prong gap in a transitional region. Thus, the two gaps form subregions of a continuous gap. The transitional region can be associated with the pickup-prong gap and/or the transfer-prong gap, with the association often not being clearly defined. As a rule, a pickup prong is retracted to the inner side of the stripping device in the transitional region, while a transfer prong emerges there to the outer side. A transfer of crop material between the rotors thus takes place in the transitional region or at least close to the latter. This transfer is promoted by the fact that the gaps merge into one another instead of being separated from one another.

One embodiment envisages that an entry region, in which the transfer prongs enter completely between the transfer-prong stripper sections, is arranged vertically above the conveying surface in at least one working position of the windrower. The entry region is the region in which the entry of the transfer prongs is complete. Any crop material still adhering to the transfer prongs is stripped from the transfer prongs at the latest in the entry region, which can also be referred to as the retraction region. This normally corresponds to the lowest point from which crop material can fall. This entry region is arranged vertically, i.e., perpendicularly, above the conveying surface. For the crop material, this results in a stage of falling from the entry region to the conveying surface. The height thereof can be, for example, at least 10% or at least 15% of the diameter of the range of movement of the transfer prongs. Since the entry region is arranged above the conveying surface in the direction of the vertical axis, even crop material which falls vertically from the entry region still lands on the conveying surface and is thus not lost. The corresponding arrangement is present in at least one working position, and preferably may be present in every working position.

A preferred alternative or additional possibility is that the entry region is offset in relation to an axis of rotation of the transfer rotor by over 70° with respect to an uppermost point of the range of movement of the transfer prongs. The entry region corresponds to the last point at which crop material is still discharged. In this embodiment, this takes place in a relatively late phase of the rotation. At the uppermost point of the range of movement, the transfer prongs move horizontally, normally parallel to the longitudinal axis. After a further rotation by 70°, they move predominantly vertically upwards. Here, therefore, the entry region lies in a region in which the transfer prongs are moving downwards, although they may have a small motion component in the horizontal direction. Insofar as it has not already been released on account of the centrifugal force, the crop material can be taken along over a relatively long distance by the transfer prongs. The entry region can furthermore preferably be offset by over 80°, particularly preferably over 90°, relative to the uppermost point. In the latter case, the transfer prongs have already passed through a reversal point in respect of the horizontal motion component when they reach the entry region.

One embodiment envisages that, in at least one working position of the windrower, a tangent to the range of movement of the transfer prongs, which runs through the point of the conveying element which is furthest forwards in relation to the longitudinal axis, encloses a first angle with a horizontal plane which is at least 60°, when measured in the direction of rotation of the transfer rotor, starting from the horizontal plane. The first angle can preferably be at least 70° or at least 80°. The tangent extends in the plane of rotation of the transfer prongs, i.e., perpendicularly to the axis of rotation of the transfer rotor. In accordance with the term “tangent”, it touches the range of movement without intersecting it. It passes through the above-described forwardmost point of the conveying element. If the angle to the tangent is measured, starting from a horizontal plane, namely in the direction of rotation of the transfer rotor, this angle is at least 60°. It can also be stated that the tangent is rotated by at least 60° relative to the horizontal plane in the direction of rotation of the transfer rotor. Since the forwardmost point of the conveying element marks the front edge of that part of the conveying surface, which can still be reached directly, crop material which is flung tangentially off the transfer rotor can still land in this region when it has already traveled through 60° relative to the uppermost point of the path of movement of the transfer prongs. This applies subject to the assumption that the crop material moves in a straight line to the conveying surface, which is not precisely correct but can nevertheless be used for estimation purposes. More particularly, it should be taken into account here that, at an angle of at least 60° beyond the uppermost point, the transfer prongs are already moving primarily downwards, proportionally, while the horizontal motion component is relatively small. The crop material flung off here is therefore deflected only to a small extent by gravity. At any rate, this embodiment ensures that even crop material that is taken along for a relatively long time by the transfer prongs is reliably taken up by the transverse conveyor.

In this context, it is regarded as an independent invention to provide a windrower in accordance with the pre-characterizing clause of claim 1 in which, in at least one working position of the windrower, a tangent to the range of movement of the transfer prongs, which runs through a point of the conveying element which is furthest forwards in relation to the longitudinal axis, encloses a first angle with a horizontal plane which is at least 60°, when measured in the direction of rotation of the transfer rotor, starting from the horizontal plane.

One embodiment envisages that the transverse conveyor can at least be arranged in such a way that the conveying surface is tilted relative to the horizontal plane towards the pickup device. This can apply, in particular, to the central region of the conveying surface. That is to say that the conveying surface (or at least the central region) is either permanently tilted in an appropriate manner or various arrangements of the transverse conveyor are possible, wherein the conveying surface is tilted towards the pickup device in at least one of the said arrangements. The conveying surface does not run horizontally but is tilted towards the pickup device, which is to say, in general, forwards in the direction of travel. The angle of inclination relative to the horizontal plane (also referred to below as the second angle) can be, in particular, between 5° and 35°, preferably between 10° and 30°, as a further preference between 15° and 25°. Irrespective of whether the conveying surface is tilted as described here, a retention device, in particular a baffle, can be arranged on an opposite side of the conveying surface from the pickup device. This can have a significantly greater tilt forwards in the direction of travel relative to the horizontal plane (e.g., over 70°) and can even have overhanging regions which project upwards in the direction of travel.

The embodiment with two rotors contributes to preventing an excessively deep pile of crop material collecting in front of the pickup rotor. This effect can be further enhanced. According to a corresponding embodiment, the windrower (preferably: the windrower unit) has a hold-down device. The hold-down device limits the upward freedom of movement of the crop material. It can apply pressure from above to the crop material even before the latter is picked up by the pickup rotor, and in this way, can prevent the crop material from piling up to an excessive extent. Moreover, it can apply pressure to the crop material already taken up by one of the rotors and/or limit the freedom of movement thereof. Depending on its position relative to the rotors, it can also determine the earliest point at which the crop material can leave the transfer rotor.

The hold-down device preferably has a rotatable hold-down roller, which is arranged at least in part in front of the pickup rotor in relation to the longitudinal axis, and a guide cover, which is arranged at least in part behind it in relation to the longitudinal axis and defines a conveying duct for crop material between itself and at least one of the rotors. The hold-down roller, which can have a smooth or profiled surface, is rotatable about an axis of rotation which normally runs parallel to the transverse axis. It exerts, in particular, a vertical pressure on the crop material in front of the pickup rotor and thus limits the piling up of the crop material. At the same time, depending on the embodiment, it can also act as a counter-holder for crop material which has already been picked up by the pickup rotor. The hold-down device furthermore has a guide cover, which is arranged at least in part behind the hold-down roller in relation to the longitudinal axis. It can adjoin the hold-down roller with a certain clearance. In particular, the guide cover can have at least one guide plate or can be designed as such. It is preferably impenetrable for crop material and has a closed surface. However, it would also be possible to conceive of embodiments in which, for example, it had a plurality of spaced guide elements, which could, in particular, be of arcuate design. The guide cover could also be referred to as a guide hood. Optionally, as a supplement to the hold-down roller, it forms a counter-holder for the crop and limits the freedom of movement thereof. A conveying duct for the crop material is thus defined between the guide cover and at least one of the rotors. By means of this duct, it is possible essentially to prevent loss of crop material, and/or to convey the crop material more effectively by the corresponding rotor.

The hold-down device is preferably suspended in such a way by means of at least one hold-down device carrier that it is at least vertically movable relative to the rotors. For its part, the hold-down device carrier can be connected directly or indirectly to the vehicle body or to a main frame of the windrower. According to one embodiment, the hold-down device carrier is connected movably to a transverse conveyor frame of the transverse conveyor. In particular, it can be connected pivotably thereto. In each case, the hold-down device carrier provides suspension of the hold-down device, which allows at least vertical movement relative to the rotors. A movement in the horizontal direction can be superimposed on the vertical movement. Here, a spring element, e.g., a hydraulic cylinder, can be used to define a rest position of the hold-down device carrier, from which it can be deflected, e.g., when the hold-down roller has to yield upwards on account of a relatively large quantity of crop material in front of the pickup rotor. The same applies to any possible yielding of the guide cover that may be necessary.

Even though a corresponding vertical mobility of the hold-down device as a whole is advantageous, provision can be made in addition to this, or possibly as an alternative, for the hold-down roller and/or the guide cover to be individually adjustable relative to the hold-down device carrier. Both in relation to the hold-down roller and to the guide cover, vertical adjustment and/or horizontal adjustment may be possible. With regard to the hold-down roller, said roller can be arranged on a roller carrier, which can be adjustable in translation and/or pivotable relative to the hold-down device carrier. Manual adjustability is possible, wherein the respectively selected position can be secured by tightening a locking screw. However, actuator adjustment would also be conceivable.

According to one embodiment, the windrower unit has a plurality of guide prongs, which extend along the longitudinal axis and guide the crop material discharged by the transfer rotor in the direction of the transverse conveyor, wherein an inclination of the guide prongs relative to the longitudinal axis is adjustable in the direction of the transverse axis and/or an inclination of the guide prongs is adjustable in the direction of the vertical axis. As a general rule, the guide prongs are spaced apart from one another in relation to the transverse axis, i.e., gaps are formed between them. The guide prongs can be made of metal but may also be made of other materials, such as plastic or composites. They can be formed by wire or rods. As an alternative, they could also be formed by sheet metal or comparable sheet-like material. The guide prongs extend along the longitudinal axis but in general do not run parallel to the latter. However, there is preferably at least one position provided in which the guide prongs run parallel to the longitudinal plane, i.e., to the plane which is defined by the longitudinal axis and the vertical axis. In particular, the hold-down device can have the guide prongs. The guide prongs can adjoin the guide cover. By way of example, they can be connected movably, in particular pivotably, to the guide cover. The guide prongs can partially define a gap between them and one of the rotors, in particular, the transfer rotor. This gap can adjoin the abovementioned conveying duct or can also be regarded as part thereof. In contrast to the guide cover, the guide prongs are generally spaced apart in such a way that crop material could get between them. However, this is normally not very problematic in the region in which the guide prongs are arranged. In particular, there is, in general, only a small risk that crop material will be completely lost, i.e., will fall back onto the ground, in this region. Normally, even the crop material which passes between the guide prongs still gets to the downstream device, in particular to the transverse conveyor. However, it would also be conceivable additionally to provide a cover above the guide prongs, and this cover can also be designed as part of the guide cover. In this way, it would be possible to prevent the loss of crop material almost completely. The guide prongs are preferably arranged at least in part above the transfer rotor. By means of the guide prongs, the crop material which is discharged by the transfer rotor can be guided in the direction of the transverse conveyor.

By their orientation, the guide prongs define a direction of movement which the crop material can follow with minimal resistance. In general, the crop material does not move exactly parallel to the direction of the extent of the guide prongs, but they nevertheless exert a directing or guiding effect on the crop material. On the one hand, this can be used to adjust the inclination of the guide prongs towards the transverse axis. That is to say that the guide prongs can be tilted by different amounts (or even not at all) to the side. As a result, the crop material, which is driven substantially in the direction of the longitudinal axis and in the direction of the vertical axis by the transfer rotor, is subject to lateral deflection. It may be stated that a velocity component in the direction of the transverse axis is imposed on the crop material. Accordingly, it tends to be thrown off on the conveying surface centrally or towards one side in relation to the transverse axis. Alternatively, or in addition, an inclination of the guide prongs relative to the longitudinal axis can be adjusted in the direction of the vertical axis. It may also be stated that, in this case, an inclination relative to the horizontal plane is adjusted. It is thereby possible, in particular, to change a throwing distance of the transfer rotor. If—when viewed from the front to the rear—the guide prongs are tilted downwards to a greater extent, the crop material is guided downwards more quickly and/or more sharply, this being synonymous with a shorter throwing distance. If the guide prongs are tilted upwards to a greater extent, a longer throwing distance is the result. Individual adjustability of single guide prongs is possible. However, it is also advantageously possible for all the guide prongs to be arranged on a prong carrier which is pivotable together with the guide prongs. The inclination can be manually adjustable since, in many cases, it can be kept constant for the cultivation of a field. As an option, however, it could also be adjustable by an actuator.

The invention furthermore makes available a method for operating a windrower. The windrower has the features of the pre-characterizing clause of claim 1. In particular, it is possible for the windrower to be designed according to the invention, that is to say that, in at least one working position of the windrower, a normal straight line, which runs perpendicular to a region of the conveying surface that is central in relation to the longitudinal axis and which runs through a point on the conveying element that is furthest forward in relation to the longitudinal axis, can at least touch a range of movement of the transfer prongs. In all cases, the windrower has at least one windrower unit, which has the pickup device and the transverse conveyor. In the method according to the invention, it is envisaged that at least one operating parameter of the windrower unit is adapted to influence a distribution of the crop material on the conveying surface. Distribution designates the proportion of the crop material, which is arranged on different regions of the conveying surface. This can relate to distribution in relation to the longitudinal axis and distribution in relation to the transverse axis. In the method according to the invention, at least one operating parameter is adapted to influence this distribution. In this context, “adapt” can mean, in particular, “adjust”, wherein the value of the operating parameter is precisely determined (apart from unavoidable and negligible inaccuracies). In some cases, it is not possible to determine the operating parameter precisely, but it can be adapted qualitatively in the sense that it is increased or reduced, for example.

Adaptation of the at least one operating parameter is worthwhile or necessary in general because the distribution can be affected by various factors outside the windrower unit. Possible relevant influences are the quantity, type, and characteristics of the crop material, moisture content, wind speed and direction, and the speed of travel of the windrower. Moreover, factors within the windrower unit can make it necessary to adapt the operating parameter, e.g., such that it is necessary to change one operating parameter because some other operating parameter has been changed. Ideally, the aim will be to achieve a specific distribution, although precision is virtually impossible on account of numerous factors, depending, inter alia, especially on the type and characteristics of the crop material. The adaptation of the parameter can be performed before the windrower is put into operation. Alternatively, or in addition, it can also be performed during operation, and it may, in some circumstances, be possible to continue operation without interruption. The operating parameter can be adapted manually or by an actuator. The latter can take place automatically or in response to a user input. Adaptation can be performed on the basis of empirical values or on the basis of a calculation. In the simplest case, it is carried out by observing the distribution which occurs during operation and adapting the at least one parameter in order to change the distribution when necessary.

Provision is preferably made for the distribution of the crop material to be detected by at least one sensor, and for the at least one operating parameter to be adapted in accordance with the detected distribution. The sensor preferably operates in a contactless manner, thus ensuring that neither the crop material nor the sensor itself is affected or impaired by the measurement. This can be, in particular, an optical sensor, e.g., a camera, which detects visible light and/or infrared light. However, it would also be possible to use other sensors that could detect the crop material on the conveying surface using radar, lidar or ultrasound, for example. Adaptation can be performed by a user on the basis of the detected distribution. However, it would also be possible for adaptation to be performed at least in part automatically.

In particular, the at least one parameter can be adapted in order to ensure that at least some of the crop material is deposited in the region of the conveying surface, which is central in relation to the longitudinal axis. Such central deposition prevents crop material from piling up in the front or rear region of the conveying surface or even from falling off the conveying surface in relatively large quantities. For example, the aim may be to achieve a distribution with which the greatest density of crop material (i.e., mass of crop material per unit of area) is obtained in the central region of the conveying surface, while it is lower in regions situated in front and behind. One particular aim here may be to utilize the entire extent of the conveying surface along the longitudinal axis, ensuring that all regions (e.g., the front, central and rear regions) are at least partially covered with crop material.

A rotational speed of the transfer rotor is advantageously adapted in order to influence the distribution. A higher rotational speed (with otherwise constant conditions) has the effect that the crop material leaves the transfer rotor earlier and is thrown further upwards or less far downwards. This, in turn, has a direct effect on the throwing distance and thus on the distribution on the conveying surface. Qualitatively, the distribution is shifted further rearwards when the rotational speed is increased, and is shifted forwards when the rotational speed is reduced. Moreover, a higher rotational speed of the transfer rotor with a constant rotational speed of the pickup rotor has the effect that crop material is taken up more quickly by the transfer rotor. That is to say that the transfer rotor delivers a quicker but less dense flow of crop material. As a result, fewer lumps may form within the crop material under certain circumstances, and this, in turn, can affect how well the crop material is released from the transfer rotor and how it behaves in flight between the transfer rotor and the conveying surface.

One embodiment envisages that a second angle, by which at least the central region of the conveying surface is tilted relative to the horizontal plane towards the pickup device, is adapted in order to influence the distribution. At least the central region of the conveying surface (advantageously, the conveying surface as a whole) is thus not horizontal but can be tilted towards the pickup device, which is to say, in general, forwards in the direction of travel. In this embodiment, the angle of inclination relative to the horizontal plane is adapted in order to influence the distribution of the crop material. The oblique positioning of the conveying surface prevents the crop material that is flung off by the transfer rotor at a considerable speed from moving too far rearwards. If a relatively small second angle is set, the crop material can move more toward the rear part of the conveying surface. If a relatively large second angle is set, the conveying surface is as it were tilted forwards and tends to hold back the crop material, with the result that it tends to remain in the front part of the conveying surface. In particular, a sufficient inclination can be used to prevent the crop material from collecting only in the rearmost region of the conveying surface and possibly piling up there. Typically, a second angle can be set to between 5° and 35°, preferably between 10° and 30°, as a further preference between 15° and 25°.

According to one embodiment of the method, the windrower unit has a hold-down device, wherein at least one position of the hold-down device relative to the rotors is adapted in order to influence the distribution. The hold-down device has already been described above. As already mentioned above, depending on its position relative to the rotors, it can inter alia determine the earliest point at which the crop material can leave the transfer rotor. In this variant of the method, at least one position of the hold-down device is adapted, and this includes the possibility that the position can be a position of an element of the hold-down device. It can be a position in relation to the longitudinal axis, in relation to the vertical axis and/or an angular position, i.e., an inclination. The latter means that the hold-down device or an element thereof can be tilted in various ways.

The hold-down device preferably has a rotatable hold-down roller, which is arranged at least in part in front of the pickup rotor in relation to the longitudinal axis, and a guide cover, which is arranged at least in part behind it in relation to the longitudinal axis and which defines a conveying duct for crop material between itself and at least one of the rotors, wherein a position of the guide cover is adapted and the geometry of the conveying duct is thereby changed in order to influence the distribution. The hold-down roller and guide cover and their possible embodiments have already been described above. In this embodiment, a position of the guide cover relative to the rotors is adapted, and this has an effect on the dimensions of the conveying duct. If the conveying duct is opened wider, crop material may, under certain circumstances, be flung off earlier by the transfer rotor than if the conveying duct is opened less wide. Correspondingly, a longer throwing distance is obtained, i.e., the crop material lands further back on the conveying surface along the longitudinal axis. In particular, a position of the guide cover can be adapted independently of the hold-down roller. This can be possible, for example, if both the guide cover and the hold-down roller are arranged on a hold-down device carrier described above, and the guide cover can be adjusted individually relative to the hold-down device carrier.

It is preferably a vertical position of the guide, which is adapted in order to influence the distribution. In particular, this can be a vertical position in relation to the rotors. It can likewise be a vertical position in relation to the hold-down device carrier. In particular, the change in the vertical position changes the extent of the conveying duct. If the guide cover is adjusted downwards, a narrower conveying duct is obtained, and, if it is adjusted upwards, a wider conveying duct is obtained.

According to one embodiment, the windrower unit has a plurality of guide prongs, which extend along the longitudinal axis and guide the crop material discharged by the transfer rotor in the direction of the transverse conveyor, wherein an inclination of the guide prongs relative to the longitudinal axis is adapted in the direction of the transverse axis and/or an inclination of the guide prongs relative to the longitudinal axis is adapted in the direction of the vertical axis in order to influence the distribution. The guide prongs and possible embodiments thereof have already been described above. In the case of the present embodiment, it is possible, on the one hand, to adapt the inclination of the guide prongs towards the transverse axis. That is to say that the guide prongs can be tilted to the side by different amounts (or even not at all), thereby adapting a lateral deflection of the crop material. Accordingly, it tends to be thrown off on the conveying surface centrally or towards one side in relation to the transverse axis. Alternatively, or in addition, an inclination of the guide prongs relative to the longitudinal axis can be adjusted in the direction of the vertical axis.

It is expressly pointed out that the above-described embodiments of the invention can be combined in each case individually, but also in any combinations with one another, with the subject matter of the main claim, provided that no technically compelling obstacles are in conflict therewith.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Further modifications and embodiments of the invention can be derived from the following description of the subject matter and the drawings.

The invention will be described below on the basis of figures. The figures are merely exemplary and do not restrict the general concept of the invention. In the figures:

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated. Further details and advantages of the invention can be found in the schematic figures described below.

The invention is described below with reference to Figures. The Figures or Figs. are purely exemplary and do not limit the general notion of the invention. In the drawings:

FIG. 1 shows a perspective view of a windrower according to the invention designed as a windrower;

FIG. 2 shows a side view of a windrower unit of the windrower from FIG. 1;

FIG. 3 shows a sectional illustration from the side of part of the windrower unit from FIG. 2;

FIG. 4 shows a perspective view of a pickup device of the windrower unit from FIG. 2;

FIG. 5 shows a perspective view of part of the windrower unit from FIG. 2;

FIG. 6A shows side views of part of the windrower unit from FIG. 2;

FIG. 6B shows side views of part of the windrower unit from FIG. 2; and

FIG. 7 shows a perspective illustration of part of a hold-down device of the windrower unit from FIG. 2.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated. The hereinafter elucidated features may also be an aspect of the invention individually or in combinations other than those shown or described, but always at least in combination with the features of the claims. Where appropriate, functionally equivalent parts are provided with identical reference numbers.

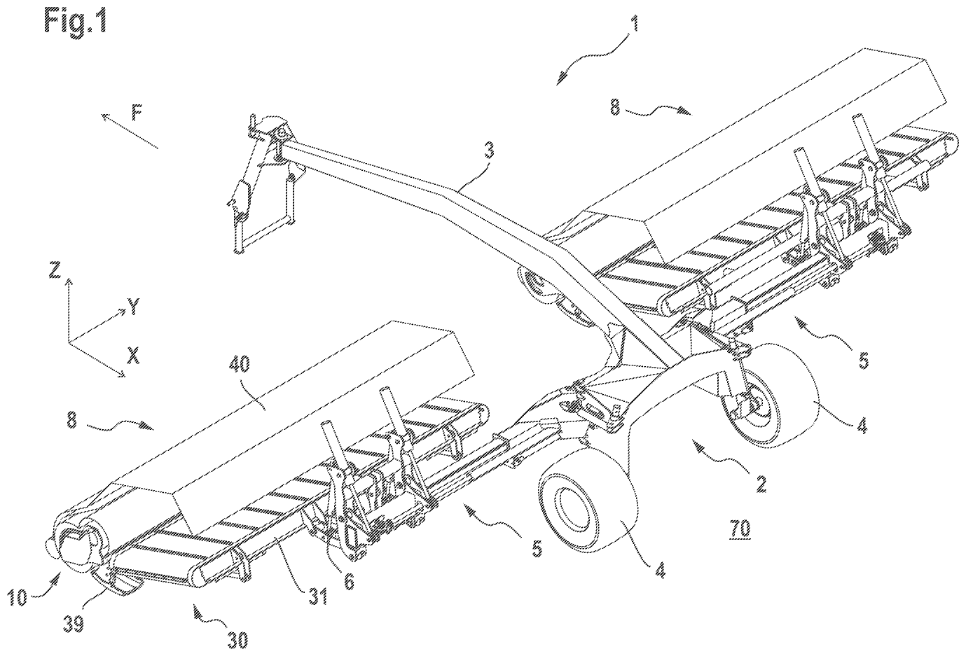

FIG. 1 shows a windrower 1 according to the invention, which is provided for towing by a tractor (not illustrated here). The windrower 1 has a main frame 2, which can be supported on the ground 70 via two wheels of an undercarriage 4. In addition, the main frame 2 has a drawbar 3, which points forwards in a direction of travel F, which extends along a longitudinal axis X, and via which it is coupled to the tractor. Two side arms 5, on each of which a windrower unit 8 is arranged, extend parallel to a transverse axis Y on both sides of the main frame 2. The two windrower units 8 and their connection to the main frame 2 are identical or mirror-symmetrical, for which reason only one windrower unit 8 is considered below in each case.

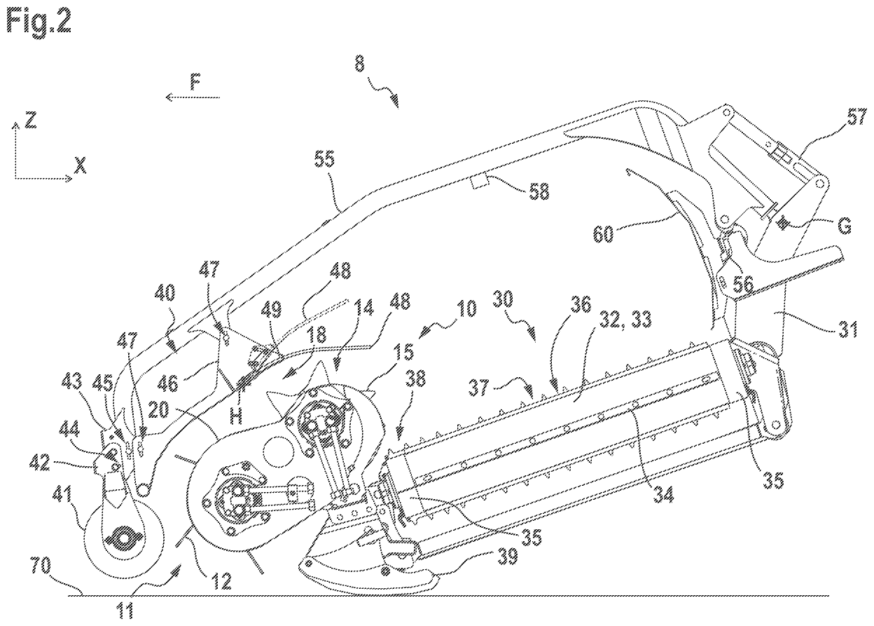

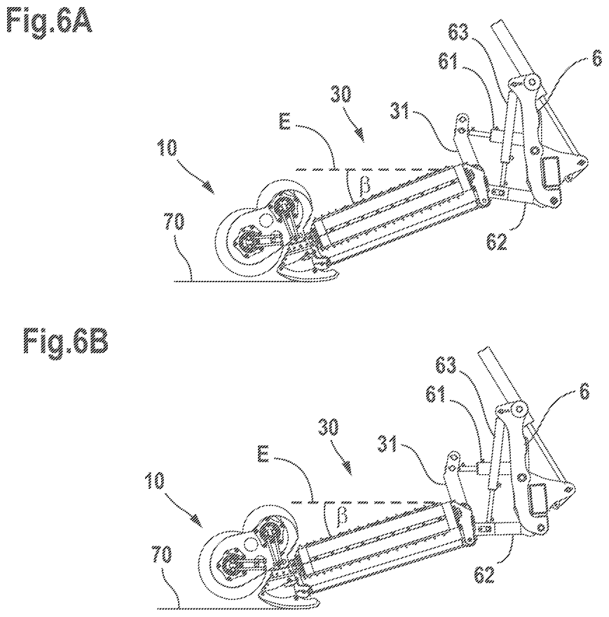

The windrower unit 8 has a pickup device 10 and a transverse conveyor 30, which is arranged behind the latter in relation to the longitudinal axis X. When the windrower 1 is towed in the direction of travel F, the pickup device 10 picks up crop material from the ground 70 and transfers it to the transverse conveyor 30. The transverse conveyor 30 has a transverse conveyor frame 31 and a conveyor belt 32, which can be driven in revolution on the said frame. The crop material is received on a conveying surface 36, shown in FIGS. 2, 3, and 5, conveyed sideways by the conveyor belt 32 in relation to the transverse axis Y and deposited in windrows on the ground 70. FIG. 1 shows a configuration of the windrower 1, which is provided for deposition of the crop material on the inside, i.e., towards the central plain of the windrower 1. In this case, the two windrower units 8 are clearly spaced apart along the transverse axis Y, and the conveyor belts 32 are driven in such a way that they each convey the crop material towards the center. In an alternative working configuration (not illustrated here), the windrower units 8 can be adjusted towards the center on the side arms 5, such that they are arranged directly adjacent to one another. The windrower unit 8 is suspended in such a way that it can be moved relative to the main frame 2 in a manner not fully explained here. As can be seen in FIGS. 6A and 6B, the transverse conveyor frame 31 is connected via an upper link actuator 61, two lower links 62, and two lower link actuators 63 to a suspension frame 6, which for its part is arranged on the side arm 5. In particular, the windrower unit 8 is vertically movable and can sense and follow the profile of the ground 70 by means of ground guidance elements 39.

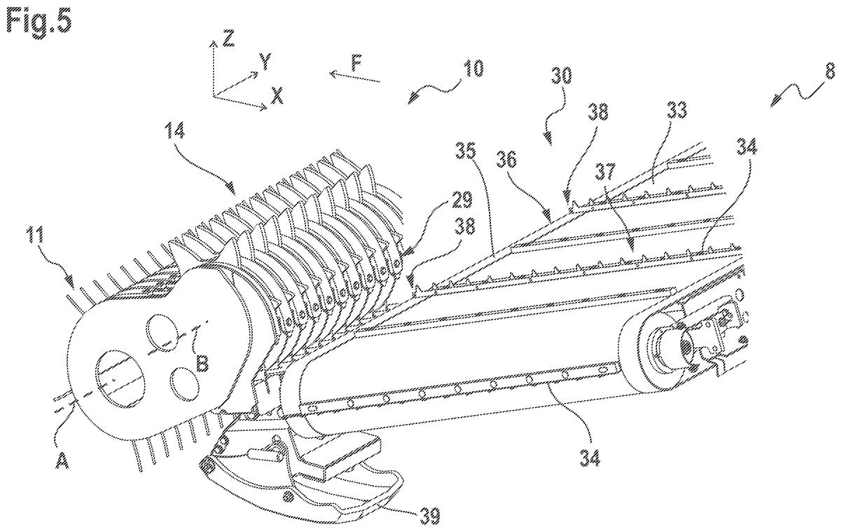

The pickup device 10 has a pickup rotor 11, which can be driven in rotation about a first axis of rotation A and is guided along the ground 70 and close to the latter, and a transfer rotor 14, which can be driven in rotation in the same direction as the pickup rotor about a second axis of rotation B and is offset rearwards in relation to the longitudinal axis X and upwards in relation to a vertical axis Z relative to the pickup rotor 11, as shown in FIG. 5. In the figures, the axes of rotation A, B extend parallel to the transverse axis Y, corresponding to alignment on level, horizontal ground 70. Owing to the mentioned mobility of the windrower unit 8, the alignment of the axes of rotation A, B may temporarily deviate from the transverse axis Y, but normally this is by what is, in particular, a small angle of at most 20°. It is also possible that not only the windrower unit 8 as a whole is movable but that the pickup device 10 is split along the transverse axis Y into two subunits which can tilt relative to one another in order to adapt to irregularities in the ground. In this case, each of the axes of rotation in the two subunits can extend differently, although deviations of less than 20° are likewise typical.

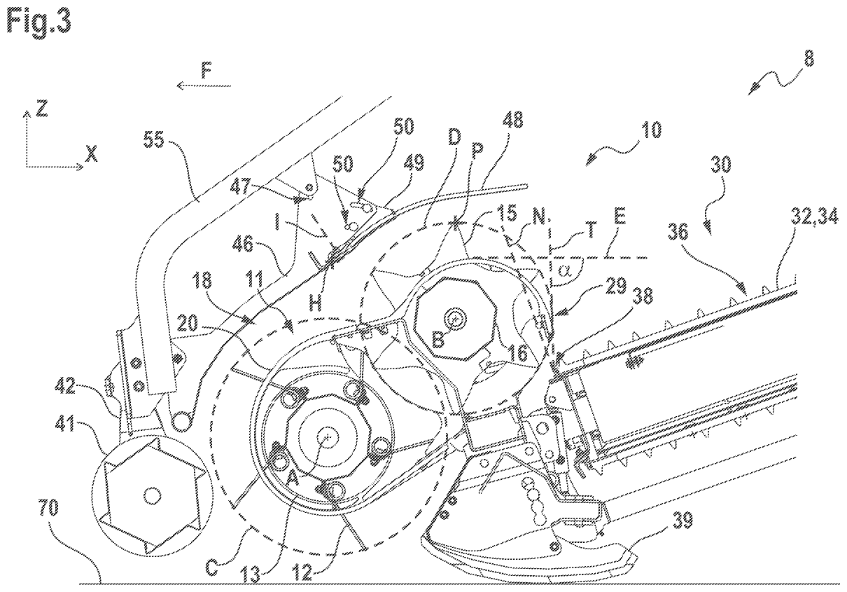

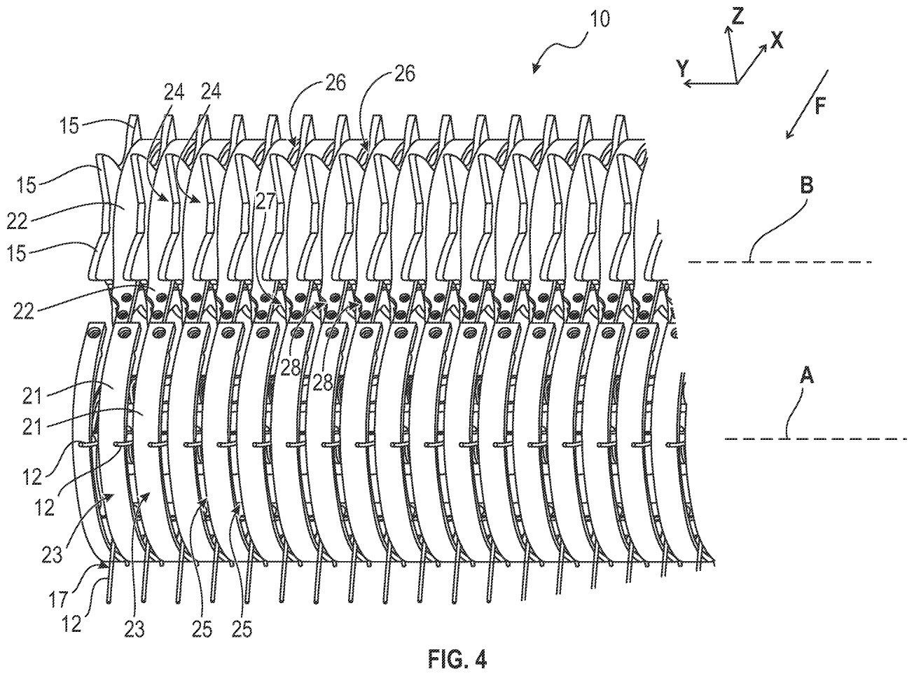

The function of the pickup device 10 is to pick up crop material from the ground 70 and to transfer it to the transverse conveyor 30. To be more precise, the pickup rotor 11 picks up the crop material and transfers it to the transfer rotor 14, which, for its part, transfers it to the transverse conveyor 30. The pickup rotor 11 has a plurality of pickup prongs 12, which in the present case are formed from spring wire. They are arranged on a rotor core 13, which is visible in FIG. 2. As can be seen, for example, in FIGS. 4 and 5, the pickup prongs 12 are grouped in a plurality of prong rings, which are spaced apart along the transverse axis Y. The transfer rotor 14 has a plurality of transfer prongs 15, which can be formed by segments made of sheet metal or else of plastic. These too are grouped into prong rings and arranged on a rotor core 16. In FIG. 1, only the cylindrical ranges of movement C, D are illustrated, instead of the respective prongs 12, 15, for the sake of clarity. As is apparent from FIG. 3, a first range of movement C of the pickup prongs 12 overlaps a second range of movement D of the transfer prongs 15 in the direction of the transverse axis Y (which is perpendicular to the plane of the drawing in FIG. 3). This is made possible by the fact that the transfer prongs 15 are arranged offset relative to the pickup prongs 12 in the direction of the transverse axis Y and can thus engage in gaps between the respective pickup prongs 12. This state of affairs is apparent, especially in FIG. 4.

The pickup device 10 furthermore has a stripping device 20, which is formed from metallic stripping elements 21, 22. The stripping device 20 defines pickup-prong stripper sections 23 arranged between the pickup prongs 12 along the transverse axis Y and defines transfer-prong stripper sections 24 arranged between the transfer prongs 15 along the transverse axis Y. In this embodiment, the respective pickup-prong stripper section 23 is formed substantially by a first stripping element 21, while the respective transfer-prong stripper section 24 is formed substantially by a second stripping element 22, which in each case adjoins a first stripping element 21 almost seamlessly. However, some other embodiment would also be possible. The pickup prongs 12 each move through pickup-prong gaps 25, which are formed between two pickup-prong stripper sections 23. The transfer prongs 15 each move through transfer-prong gaps 26, which are each formed between two transfer-prong stripper sections 24. Each pickup-prong gap 25 merges into a transfer-prong gap 26 in a transitional region 27. In the course of their rotary motion, the pickup prongs 12 retract to an inner side of the stripping device 20 in the transitional region 27, while the transfer prongs move towards the outer side from the inner side of the stripping device 20 in the transitional region 27. In the transitional region 27, the stripping device 20 has a guide edge 28, which delimits the pickup-prong gap 25. This guide edge 28 is inclined, relative to a rotation plane perpendicular to the first axis of rotation A of the pickup rotor 11, towards the axis of rotation A in the direction of the adjacent transfer-prong gap 26. Thus, crop material, which is located between the pickup prong 12, which is retracting to the inner side, and the guide edge 28, is guided sideways in the direction of the transfer-prong gap 26 and thus in the direction of the transfer rotor 14. In an entry region 29, which is arranged to the rear of the stripping device 20 in relation to the longitudinal axis X, the transfer prongs 15 are retracted again between the transfer-prong stripper sections 24.

Since the transfer rotor 14 is arranged at least in part higher than the pickup rotor 11, the crop material is lifted in a total of two stages in relation to the vertical axis Z. The crop material lying in a certain depth on the ground 70 is first of all taken up by the pickup prongs 12 and conveyed by these upwards and proportionally rearwards along the longitudinal axis X. Some of it is stripped off by the stripping device 20, but some of it is also taken over directly by the transfer prongs 15 of the transfer rotor 14. In all cases, the crop material is ultimately taken over by the transfer rotor 14, which in turn lifts the crop material in relation to the vertical axis Z and conveys it rearwards in relation to the longitudinal axis X. Overall, the crop material can be brought to a relatively great height above the ground 70, while the pickup rotor 11 is comparatively small, wherein the range of movement C of a pickup prong 12 has a diameter of 60 centimeters, for example. This, in turn, has the effect that the pickup prongs 12 take up the crop material in a phase of movement in which they are already moving predominantly upwards and not primarily forwards in the direction of travel F. This, therefore, very largely prevents the pickup rotor 11 from flinging the crop material forwards or merely pushing it ahead of itself. The great conveying height achieved overall in this way is in turn, advantageous for the transfer of the crop material to the transverse conveyor 30. The conveying height is also achieved by virtue of the fact that the transfer rotor is arranged at least in part above the conveying surface 36.

As is apparent from FIGS. 2, 3, and 4, the conveyor belt 32 has a flexible belt body 33 and a plurality of rigid conveying bars 34, which are connected to the belt body 33. In this exemplary embodiment, the conveying bars 34 project partially beyond the belt body towards the front and form a forwardmost point 38 of the conveyor belt 32 in relation to the longitudinal axis X. This point is arranged above a side plate 35, which is connected rigidly to the transverse conveyor frame 31 and is arranged in part below the belt body 33 and supports the latter. Since crop material in this region is also taken along by the conveying bars 34, this region—together with the belt body 33—forms part of the conveying surface 36. As can be seen from FIG. 3, a normal straight-line N, which runs perpendicular to a central region 37 of the conveying surface 36 and runs through the forwardmost point 38, intersects the range of movement D of the transfer prongs 15. Moreover, a tangent T to the range of movement D, which runs through the forwardmost point 38, is inclined by a first angle α of about 87° relative to a horizontal plane E. This first angle α is measured in the direction of rotation of the transfer rotor 14, starting from the horizontal plane E. Both the arrangement of the normal straight-line N and the steep inclination of the tangent T are signs that the crop material can be taken along over a relatively long distance by the transfer prongs 15 and is nevertheless reliably received on the conveying surface 36. A further aspect in this context is that the entry region 29 is offset by about 93° relative to a point P of the range of movement D, which is uppermost in relation to the vertical axis Z. This entry region 29, in which at the latest any crop material still adhering to the transfer prongs 15 is stripped off, is arranged vertically above the conveying surface 36. That is to say that even this crop material normally lands reliably on the conveying surface 36. In the process, it is thrown off and not simply pushed or pressed onto the conveying surface 36. Throwing it off reduces the risk of damage as compared with pushing it on or pressing it.

In the context of a method according to the invention, various operating parameters of the windrower unit 8 can be adapted in order to optimize a distribution of the crop material on the conveying surface 36. In this case, the aim is especially to ensure that at least some of the crop material is thrown on to the central region 37. Uniform distribution of the crop material on the conveying surface 36 is also desirable in order to prevent accumulation that could lead to damage to the crop material. The current distribution can be detected by means of a sensor 58, in this case, a camera. Various options for adapting operating parameters are available, and these will be explained below.

Both the rotational speed of the pickup rotor 11 and that of the transfer rotor 14 can be adjusted, more specifically, independently of one another. In particular, the rotational speed of the pickup rotor 11 can be adjusted as a function of the speed of travel of the windrower 1 and of the quantity and possibly the characteristics of the crop material on the ground 70. The rotational speed of the pickup rotor 11 normally results in a sensible minimum rotational speed of the transfer rotor 14, which is necessary to transport the accepted crop material onwards with sufficient speed. Furthermore, the rotational speed of the transfer rotor 14 can be selected in accordance with further factors, in particular in order to influence the distribution of the crop material on the conveying surface 36. It can be selected so that some of the crop material can detach itself from the transfer rotor 14 by virtue of the centrifugal force and is thus not simply stripped off but is thrown or flung. As a result, the crop material does not simply fall down where it would land on a region of the conveying surface 36, which is adjacent to the pickup device 10, i.e., close to the forwardmost point 38. On the contrary, the crop material is also, and, in particular, preferentially, thrown predominantly towards the central region 37 of the conveying surface 36 and also, in part, towards the opposite end from the pickup device 10. In general, the distribution of the crop material is shifted further rearwards in relation to the longitudinal axis X when the rotational speed of the transfer rotor 14 is increased.

To prevent the crop material from getting too far back in relation to the longitudinal axis X, the conveying surface 36 is, on the one hand, tilted forwards in the direction of the pickup device 10 in relation to the horizontal plane E, wherein, as an additional measure, the windrower unit 8 has a baffle 60 at the rear of the transverse conveyor 30. As is apparent from FIGS. 6A and 6B, a second angle β of the conveying surface 36 relative to the horizontal plane E can be adapted by activating the upper link actuator 61 and the lower link actuators 63 differently. FIG. 6A shows a second angle β of about 22°, while FIG. 6B shows an angle of inclination of about 17°. In FIG. 6B, in comparison with FIG. 6A, the upper link actuator 61 is retracted, and the lower link actuators 63 are extended, wherein the lower links 62 pivot downwards. The larger second angle β in FIG. 6A leads qualitatively to the distribution of the crop material being shifted forwards in the direction of travel F.

In order to promote efficient pickup and conveying of the crop material, the windrower unit 8 furthermore has a hold-down device 40. This is connected to the transverse conveyor frame 31 by means of a hold-down device carrier 55. In FIG. 1, the hold-down device 40 and the hold-down device carrier 55 are illustrated only schematically, while their precise structure is apparent from FIGS. 2, 3, and 7. The hold-down device 40 has a hold-down roller 41, which is rotatably mounted on a roller carrier 42, which, for its part, is connected via an intermediate element 43 to the hold-down device carrier 55. In this case, a position of the roller carrier 42 on the hold-down device carrier 55 can be varied. On the one hand, a first adjustment guide 44 is provided for this purpose, the said guide being formed by a slotted hole in the roller carrier 42, and a screw passed through this hole and connected to the intermediate element 43. Loosening the screw enables the roller carrier 42 to be pivoted relative to the intermediate element 43, thereby essentially enabling a position of the hold-down roller 41 to be changed in the direction of the longitudinal axis X before the screw is tightened again. By means of a second adjustment guide 45, the intermediate element 43 can be adjusted in height together with the roller carrier 42 and the hold-down roller 41. On the one hand, the hold-down roller 41 ensures that the crop material cannot pile up too high in front of the pickup rotor 11. On the other hand, it forms a counter-holder for crop material that has already been taken up by the pickup rotor 11. Above the hold-down roller and behind it in relation to the longitudinal axis X there is an adjoining guide cover 46, which is designed as a guide plate. The guide cover 46 is impenetrable for crop material and defines a conveying duct 18 between itself and the rotors 11, 14. It prevents crop material from becoming detached prematurely from one of the rotors 11, 14.

The guide cover 46 is also adjustably connected to the hold-down device carrier 55, for which purpose third adjustment guides 47 are provided. Finally, the hold-down device carrier 55 together with the hold-down device 40, is pivotable as a whole relative to the transverse conveyor frame 31 about a pivoting axis G. Its pivoting position can be influenced by means of a hydraulic cylinder 56. Adaptation to the current quantity or characteristics of the crop material, for example, is thereby possible. A freedom of movement of the hold-down device carrier 55 can be adjusted by means of a pivot limiter 57, which is arranged between the hold-down device carrier 55 and the transverse conveyor frame 31. Both by means of the adaptation of the pivoting position of the hold-down device carrier 55 and the associated change in the position of the hold-down device 40 overall and by means of the adaptation of the position, in particular the vertical position, of the guide cover 46, it is possible to influence the width of the conveying duct 18. This too can, in turn, influence the distribution of the crop material on the conveying surface 36.

A plurality of guide prongs 48, which extend rearwards in relation to the longitudinal axis X, is connected to the guide cover 46. They can be formed by wire, e.g., spring wire. They are arranged in their entirety on a prong carrier 49, which is pivotable relative to the guide cover about a pivoting axis H running parallel to the transverse axis Y. This is implemented by means of fourth adjustment guides 50. By changing the inclination of the guide prongs 48 relative to the horizontal plane E, the throwing distance of the crop material can be significantly influenced. FIG. 2 uses a solid line to illustrate a minimum inclination which, given otherwise identical parameters, produces the shortest throwing distance, and uses a dotted line to illustrate a maximum inclination, which leads to a maximum throwing distance. The respectively suitable setting depends on various parameters, in particular, the rotational speed of the transfer rotor 14 and the characteristics of the crop material. The inclination can be adapted in order to influence the distribution of the crop material on the conveying surface 36.

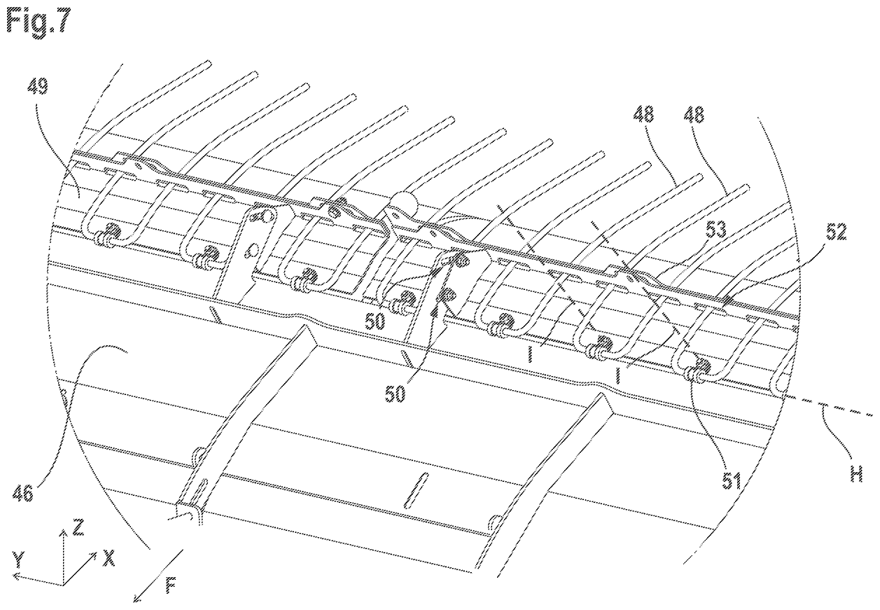

By virtue of their parallel, elongate structure, which is clearly apparent in FIG. 7, the guide prongs not only limit the trajectory of the crop material in relation to the vertical axis Z but also influence the movement of the crop material along the transverse axis Y. In FIG. 6, each guide prong 48 is arranged parallel to a longitudinal plane defined by the longitudinal axis X and the vertical axis Y. However, its inclination in the direction of the transverse axis Y is variable. In the embodiment illustrated here, two adjacent guide prongs 48 are, in each case, connected integrally to one another and fastened to the prong carrier 49 by means of a hose clip 51. The hose clip 51 is pivotable about a pivoting axis I. Each guide prong 48 is guided, on the one hand, by a slotted hole 52 formed on the prong carrier 49 and extending parallel to the transverse axis Y and, on the other hand, by a hole (not visible in the figures) in an adjusting plate 53, which can be locked on the prong carrier 49 by means of screws. By shifting the adjusting plate 53 parallel to the transverse axis Y, it is possible to simultaneously adjust the inclination of a plurality of pairs of guide prongs 48. In this case, the inclination can be adapted to the currently selected conveying direction of the transverse conveyor 30. That is to say that, when the transverse conveyor 30 is currently conveying to the left when viewed in the direction of travel F, the inclination of the guide prongs 48 is adapted in such a way that their tips shift to the left. This ensures that a speed component in the intended direction is imparted to the crop material even before it reaches the conveying surface 36, assisting and accelerating removal by the transverse conveyor 30. In all cases, the inclination of the guide prongs 8 with respect to the transverse axis Y influences the distribution of the crop material on the conveying surface 36.

Another possibility for influencing the distribution of the crop material on the conveying surface 36 consists in adaptation of a conveying speed of the conveyor belt 32. If the conveyor belt 32 moves more quickly, the crop material is transported away more quickly sideways in a corresponding fashion, which, in particular, reduces the risk in the case of large quantities of crop material that crop material will accumulate or pile up on the conveying surface 36.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 1 | Windrower |
| 2 | Main frame |
| 3 | Drawbar |
| 4 | Undercarriage |
| 5 | Side arms |
| 6 | Suspension Frame |
| 8 | Windrower unit(s) |
| 10 | Pickup device |
| 11 | Pickup rotor |
| 12 | Pickup prongs |
| 13 | Rotor core |
| 14 | Transfer rotor |
| 15 | Transfer prongs |
| 16 | Rotor core |
| 18 | Conveying duct |
| 20 | Stripping device |
| 21 | First metallic stripping element(s) |
| 22 | Second metallic stripping element(s) |
| 23 | Pickup-prong stripper sections |
| 24 | Transfer-prong stripper sections |
| 25 | Pickup-prong gaps |
| 26 | Transfer-prong gap |
| 27 | Transitional region |
| 28 | Guide edge |
| 29 | Entry region |
| 30 | Transverse conveyor |
| 31 | Transverse conveyor frame |
| 32 | Conveyor belt |
| 33 | Flexible belt body |
| 34 | Conveying bars |
| 35 | Side plate |
| 36 | Conveying surface |
| 37 | Central region |
| 38 | Forwardmost point of conveyor belt |
| 39 | Ground guidance elements |
| 40 | Hold-down device |
| 41 | Hold-down roller |
| 42 | Roller carrier |
| 43 | Intermediate element |
| 44 | First adjustment guide |
| 45 | Second adjustment guide |
| 46 | Adjoining guide cover |
| 47 | Third adjustment guides |
| 48 | Guide prongs |
| 49 | Prong carrier |
| 50 | Fourth adjustment guides |
| 51 | Hose clip |
| 52 | Slotted hole |
| 53 | Adjusting plate |
| 55 | Hold down device carrier |
| 56 | Hydraulic cylinder |
| 57 | Pivot limiter |
| 58 | Sensor |
| 60 | Baffle |
| 61 | Upper link actuator |
| 62 | Two lower links |
| 63 | Two lower link actuators |
| 70 | Ground |
| A | First axis of rotation |
| C | First cylindrical range of movement |
| D | Second cylindrical range of movement |
| E | Horizontal Plane |
| F | Direction of travel |
| G | Pivoting axis |
| H | Pivoting axis |
| I | Pivoting axis |
| N | Normal straight line |
| P | Point in the range of movement D |
| T | Tangent |
| X | Longitudinal axis |
| Y | Transverse axis |
| Z | Vertical axis |
| α | First angle |
| β | Second angle |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein, refers to slight variations in numerical quantities with respect to any quantifiable variable. Inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes a structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

1-15. (canceled)

16. A windrower (1) comprising of:
at least one pickup device (10), which has a pickup rotor (11) and a transfer rotor (14), which can be driven in the same direction about axes of rotation (A, B) which extend at least predominantly along a transverse axis (Y), wherein the pickup rotor (11) is configured to pick up agricultural crop material from the ground (70) by means of pickup prongs (12), to lift it in relation to a vertical axis (Z) and to transfer it to the transfer rotor (14), which is arranged at least in part higher than the pickup rotor (11) and is configured to take over the crop material by means of transfer prongs (15), to lift it at least initially in relation to the vertical axis (Z) and to transfer it to a downstream transverse conveyor (30), which is arranged at least in part behind the pickup device (10) in relation to a longitudinal axis (X) and is configured to receive the crop material transferred by the transfer rotor (14) on a conveying surface (36), to convey it along the transverse axis (Y) by means of a conveying element (32) and to deposit it in windrows on the ground (70), wherein the transfer rotor (14) is configured to discharge at least some of the crop material above the conveying surface (36) in relation to the vertical axis (Z) and to throw it onto the said surface, whereby in at least one working position of the windrower (1), a normal straight line (N), which runs perpendicular to a region (37) of the conveying surface that is central in relation to the longitudinal axis (X) and which runs through a point (38) on the conveying element (32) that is furthest forward in relation to the longitudinal axis (X), at least touches a range of movement (D) of the transfer prongs (15).

17. The windrower according to claim 16, wherein the transfer prongs (15) engage between the pickup prongs (12) in such a way that the ranges of movement (C, D) of the transfer prongs (15) and the pickup prongs (12) overlap when viewed along the transverse axis (Y).

18. The windrower according to claim 16, wherein the pickup device (10) has a stripping device (20) with pickup-prong stripper sections (23) and pickup-prong gaps (25), which are formed therebetween in relation to the transverse axis (Y) and through which the pickup prongs (12) at least partially project, and transfer-prong stripper sections (24) and transfer-prong gaps (26) formed therebetween, through which the transfer prongs (15) at least partially project, wherein the transfer-prong stripper sections (24) are designed in such a way that, as the transfer rotor (14) rotates, the transfer prongs (15) enter between them.

19. The windrower according to claim 16, wherein an entry region (29), in which the transfer prongs (15) enter completely between the transfer-prong stripper sections (24), is arranged vertically above the conveying surface (36) in at least one working position of the windrower (1).

20. The windrower according to claim 19, wherein the entry region (29) is offset in relation to an axis of rotation (B) of the transfer rotor (14) by over 70° with respect to an uppermost point (P) of the range of movement (D) of the transfer prongs (15).

21. The windrower according claim 16, wherein at least one working position of the windrower (1), a tangent (T) to the range of movement (D) of the transfer prongs (15), which runs through a point (38) of the conveying element (32) which is furthest forwards in relation to the longitudinal axis (X), encloses a first angle (a) with a horizontal plane which is at least 60°, when measured in the direction of rotation of the transfer rotor (14), starting from the horizontal plane.

22. A method for operating a windrower at least one pickup device (10), which has a pickup rotor (11) and a transfer rotor (14), which can be driven in the same direction about axes of rotation (A, B) which extend at least predominantly along a transverse axis (Y), wherein the pickup rotor (11) is configured to pick up agricultural crop material from the ground (70) by means of pickup prongs (12), to lift it in relation to a vertical axis (Z) and to transfer it to the transfer rotor (14), which is arranged at least in part higher than the pickup rotor (11) and is configured to take over the crop material by means of transfer prongs (15), to lift it at least initially in relation to the vertical axis (Z) and to transfer it to a downstream transverse conveyor (30), which is arranged at least in part behind the pickup device (10) in relation to a longitudinal axis (X) and is configured to receive the crop material transferred by the transfer rotor (14) on a conveying surface (36), to convey it along the transverse axis (Y) by means of a conveying element (32) and to deposit it in windrows on the ground (70), wherein the transfer rotor (14) is configured to discharge at least some of the crop material above the conveying surface (36) in relation to the vertical axis (Z) and to throw it onto the said surface, wherein the windrower (1) has at least one windrower unit (8), which has the pickup device (10) and the transverse conveyor (30), includes at least one operating parameter of the windrower unit (8) is adapted to influence a distribution of the crop material on the conveying surface (36).

23. The method according to claim 22, wherein the distribution of the crop material is detected by at least one sensor (58), and the at least one operating parameter is adapted in accordance with the detected distribution.

24. The method according to claim 22, wherein the at least one parameter is adapted in order to ensure that at least some of the crop material is deposited in a region (37) of the conveying surface (36) that is central in relation to the longitudinal axis (X).

25. The method according to claim 22, wherein a rotational speed of the transfer rotor (14) is adapted in order to influence the distribution.

26. The method according to claim 24, wherein a second angle (b), by which at least the central region (37) of the conveying surface (36) is tilted relative to the horizontal plane towards the pickup device (10), is adapted in order to influence the distribution.

27. The method according to claim 22, wherein the windrower unit has a hold-down device (40), wherein at least one position of the hold-down device (40) relative to the rotors (11, 14) is adapted in order to influence the distribution.

28. The method according to claim 27, wherein the hold-down device (40) has a rotatable hold-down roller (41), which is arranged at least in part in front of the pickup rotor (11) in relation to the longitudinal axis (X), and a guide cover (46), which is arranged at least in part behind it in relation to the longitudinal axis (X) and defines a conveying duct (18) for crop material between itself and at least one of the rotors (11, 14), wherein a position of the guide cover is adapted, and the geometry of the conveying duct (18) is thereby changed in order to influence the distribution.

29. The method according to claim 28, wherein a vertical position of the guide cover (46) is adapted in order to influence the distribution.

30. The method according to claim 22, wherein the windrower unit has a plurality of guide prongs (48), which extend along the longitudinal axis (X) and guide the crop material discharged by the transfer rotor (14) in the direction of the transverse conveyor (30), wherein an inclination of the guide prongs (48) relative to the longitudinal axis (X) is adapted in the direction of the transverse axis (Y) and/or an inclination of the guide prongs (48) relative to the longitudinal axis (X) is adapted in the direction of the vertical axis (Z) in order to influence the distribution.
